(19) United States
(12) Patent Application Publication
(10) Pub. No.: US 2011/0219016 A1
(43) Pub. Date: Sep. 8, 2011

(54) Stream Mining via State Machine and High Dimensionality Database

(75) Inventors: Michael P. Card, Manlius, NY (US); Paul G. Springer, Manlius, NY (US)

(73) Assignee: SRC, INC., North Syracuse, NY (US)

(21) Appl. No.: 12/717,201

(22) Filed: Mar. 4, 2010

(51) Int. Cl. G06F 17/30

(52) U.S. Cl. 707/769; 707/802; 707/E17.005; 707/E17.014; 707/E17.044

(57) ABSTRACT

A system and method for stream mining using state machines and high-dimensionality databases. After a data stream is digitized, a stream analyzer searches a high-dimensionality data structure containing state machine parameters to determine which state machines to activate and execute. A signal classifier creates the state machine parameters stored in the high-dimensionality data structure using a second high-dimensionality data structure programmed with information about signals of interest. If a state machine identifies a signal of interest, the system can optionally alert the user.

### BACKGROUND OF THE INVENTION

1. Field of the Invention

The present invention relates to high speed computerized data mining, and, more specifically, to high speed computerized data mining using state machines and high-dimensionality data structures.

2. DESCRIPTION OF THE RELATED ART

In a highly electronic and digitized environment, there are often multiple overlapping data signals and other electronic data tokens. Classifying the individual signals or packets of data within this dense and noisy environment can be challenging. Since the number and complexity of signals within data streams tend increase over time, the challenge of signal classification is increasingly difficult and thus requires new and innovative solutions.

One of the goals of data stream management and mining systems is to rapidly identify signals of interest among multiple signals using an architecture that accommodates a variety of signal types and allows reasonably simple changes to the signal signature set. Such a system would allow the user to quickly and efficiently adapt the system to identify new or different signals of interest.

Among the many types of data streams that are often mined for particular signals or data packets of interest are communication and electronic emitter streams as well as voice identification, all of which are typically crowded with overlapping signals. Most current data mining systems, however, are slow and inefficient or are only able to recognize a limited variety of signals. As a result, a need exists for a data stream mining system that can rapidly classify a wide variety of signals. Additionally, a need exists for a data stream mining system that can be efficiently modified to identify new signals of interest depending on the classification or identification requirements of the user.

### BRIEF SUMMARY OF THE INVENTION

It is therefore a principal object and advantage of the present invention to provide a system for data stream mining that can rapidly classify a wide variety of signals.

It is another principal object and advantage of the present invention to provide a data mining system with a signal definition set that can easily be modified, including in the field.

It is yet another principal object and advantage of the present invention to provide a data stream mining system that uses concurrently operating state machines on a field-programmable gate array.

It is a further principal object and advantage of the present invention to provide a data stream mining system that employs a programmed database of signals which is used to create stored state machine parameters.

In accordance with the foregoing objects and advantages, the present invention provides a system for stream mining comprising: (1) a digitized data stream; (2) a stream analyzer comprising a high-dimensionality data structure storing state machine parameters, programmable logic devices for executing the stream analyzer functions, and a first input/output handler; (3) a signal classifier comprising a second high-dimensionality data structure storing information about signals of interest, and a second input/output handler, wherein the first and second input/output handlers are in direct communication.

The invention also provides a method for signal classification or identification comprising the steps of: (1) receiving and digitizing a signal data stream; (2) searching a high-dimensional data structure to determine which state machines to execute, wherein the high-dimensional data structure stores state machine parameters created from a second high-dimensional data structure which is programmed with information about signals of interest; (4) activating the identified state machine and executing the state machine using the data; and (5) optionally alerting the user to an identified or categorized signal of interest.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a system for classifying simulated signals according to one embodiment of the invention.

FIG. 2 is a flowchart showing an example overview of a method of signal classification according to one embodiment of the invention.

### DETAILED DESCRIPTION OF THE INVENTION

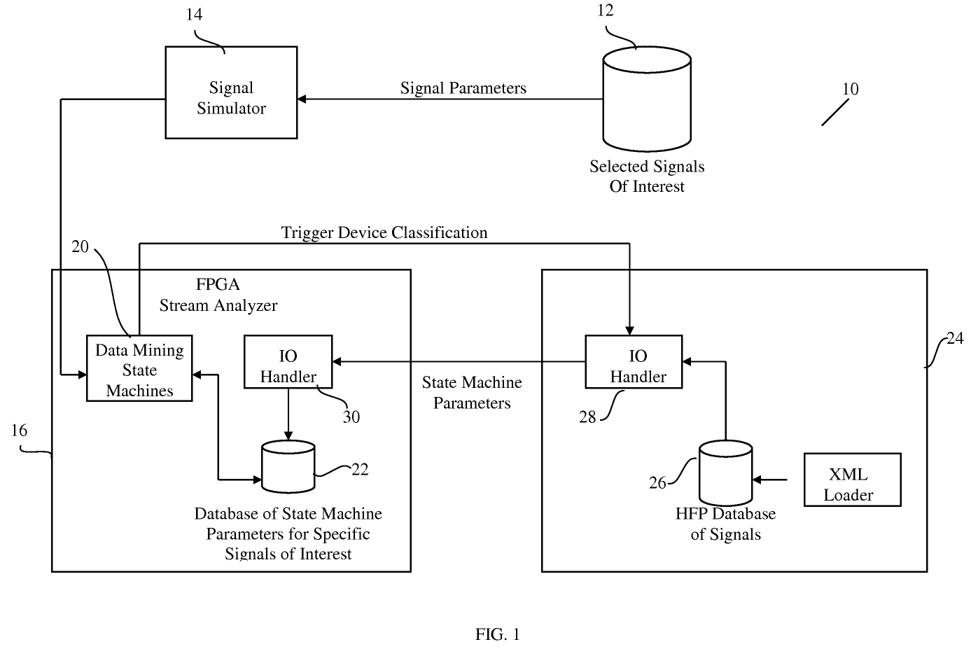

Referring now to the drawings, wherein like reference numerals refer to like parts throughout, there is seen in FIG. 1 an illustrative system 10 for classifying simulated signals according to the present invention. A signal database 12 is programmed with parameters of any number of signals of interest. This could include any type of data packet or signal that the system's signal simulator 14 can reproduce. During data mining using system 10, signal database 12 selects a set of signal parameters and sends those to signal simulator 14. Signal simulator 14 uses the parameters to simulate a signal of interest and sends the signal to the stream analyzer 16.

Stream analyzer 16 comprises a number of elements in system 10, including state machine parameter data storage structure 22. The data storage structures of the present invention can be any device used to permanently or temporarily store data, including but not limited to hard drives, servers, or flash memory. In one embodiment, state machine parameter data storage structure 22 preferably uses a high performance framework. This object database manager kernel allows high-dimensional indexing capability for rapid and efficient searches of multi-dimensional data objects. Additionally, range queries and nearest neighbor queries can be performed simultaneously on many attributes. In a preferred embodiment, stream analyzer 16 functions are executed on a programmable logic device such as a field-programmable gate array (“FPGA”). Once stream analyzer 16 receives, digitizes, and stores the signal, the signal is analyzed to determine which of the state machines 20 should be executed using the data. This determination is accomplished by searching the state machine parameters stored on data storage structure 22. The data stream can be analyzed as a complete unit, or can be sectioned into data tokens such as detections, pulses, or time periods that are then parameterized. In one embodiment, the state machine parameters are searched using the parameterized data in order to identify a programmable logic device programmed with a parameter that satisfies or matches a parameter of the parameterized data stream.

The state machine parameters stored in parameter data storage structure 22 are loaded from the signal classifier 24. Signal classifier 24 contains a database of possible signals 26, which is programmed by the user with information about signals of interest, including signal parameters. In one embodiment, the signal data storage structure 26 uses a high performance framework similar to the preferred framework of state machine parameters database 22. The information about signals of interest is used to generate state machine parameters which are transferred to the input/output (“IO”) handler 28 of signal classifier 24. IO handler 28, also known as an input/output device or input/output interface, in turn transfers the state machine parameters to the IO handler 30 of stream analyzer 16, which transfers the parameters to state machine parameter database 22. In one embodiment of the invention, signal classifier 24 is a computer system including a CPU and writable memory.

Stream analyzer 16 employs many independent state machines 20 which reference the received stream data and execute on a logic device such as a FPGA. Although state machines 20 are designed to execute independently, they can execute concurrently on the FPGA, thereby greatly increasing the speed of data analysis. As the data stream progresses and is sent to state machines 20, some of the state machines disqualify and inactivate themselves, some successfully complete a token stream and identify a transmitter, and new state machines are activated as deemed appropriate by stream analyzer 16.

In addition to classifying the source or transmitter of a signal, the data mining system of the present invention can be used to identify the operational mode of the source as well as payload meaning and significance, depending on the programmed parameters of the system.

While the system of FIG. 1 is designed to test or train the data mining system, another embodiment of the present invention receives and stores one or more data streams in a received stream data database 18.

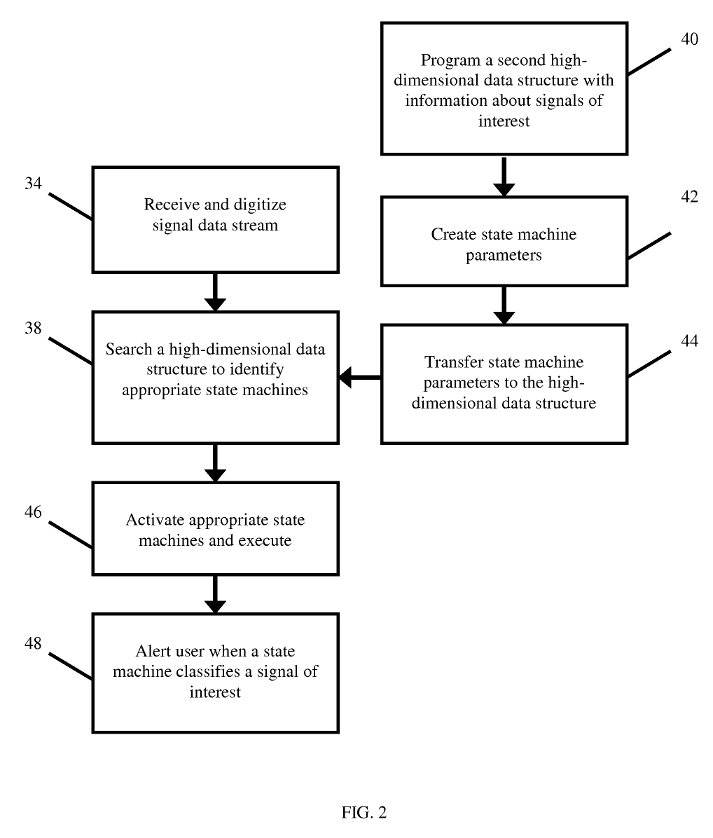

FIG. 2 is a flowchart showing an example overview of signal classification using according to one embodiment of the invention. As an initial step 34, signal(s) are received and digitized or organized to create a data stream. The signal can be a wide array of receivable signals including communications, electronic emitter streams, or any other signal capable of transmitting information.

In step 38, the system analyzes the signal stream data and searches a high-dimensional data storage structure—the database of state machine parameters for specific signals of interest—in order to identify which of the state machines should be executed using the data. In a preferred embodiment, the state machines are programmable logic device such as a field-programmable gate array (“FPGA”). The high-dimensional data storage structure contains data created in steps 40 through 44. In step 40, a second high-dimensional structure—the database of signals—is programmed by the user with information about signals of interest. In step 42, the information about signals of interest is used to generate state machine parameters, and in step 44 the parameters are transferred to the database of state machine parameters.

In step 46, the system activates the appropriate state machines and executes using the data. As the data stream progresses and is sent to the state machines, some of the state machines disqualify and inactivate themselves, some successfully complete a token stream and identify a transmitter, and new state machines are activated as deemed appropriate by the stream analyzer.

Lastly, in step 48 the system alerts the user when one of the state machines identifies or classifies a signal of interest. This could include, but is not limited to, audible, visual, or electronic alerts sent to a user of the system. Depending on how the system is used, this step can be optional. Alternatively, the system can record all identified signals of interest, create a printout of identified signals, or visualize the identified signals on a screen for the user.

Although the present invention has been described in connection with a preferred embodiment, it should be understood that modifications, alterations, and additions can be made to the invention without departing from the scope of the invention as defined by the claims.

What is claimed is:

1. A method for analyzing information from a data source, the method comprising:
programming a first data storage structure with information about a signal of interest;
creating a programmable logic device parameter using the information about said signal of interest;
storing the programmable logic device parameter to a second storage data structure;
programming at least one of a plurality of programmable logic devices with said logic device parameter;
providing a digitized data stream from said data source;
identifying which of said plurality of programmable logic devices to execute; and
executing an identified programmable logic device with said digitized data stream.

2. The method of claim 1, wherein the plurality of programmable logic devices comprise a field-programmable gate array.

3. The method of claim 1, further comprising:
identifying the signal of interest.

4. The method of claim 3, further comprising:
alerting a user to the signal of interest.

5. The method of claim 1, further comprising:
sectioning the digitized data stream.

6. The method of claim 1, further comprising:
parameterizing the digitized data stream.

7. The method of claim 6, further comprising:
searching the second data storage structure to determine whether at least one of said plurality of programmable logic devices is programmed with a parameter of the parameterized data stream.

8. The method of claim 1, further comprising:
storing said digitized data stream in a third data storage structure.

9. A system for analyzing information from a data source, the system comprising:
a digitized data stream;
a signal classifier comprising a first data storage structure programmed with information about a signal of interest, wherein the signal classifier is adapted to generate a programmable logic device parameter; and
a stream analyzer comprising a second data storage structure in communication with the first data storage structure and programmed with said programmable logic device parameters, and a plurality of programmable logic devices adapted to execute the digitized data stream, wherein the stream analyzer is adapted to identify which of the programmable logic devices to execute with the digitized data stream.

10. The system of claim 9, wherein the plurality of programmable logic devices comprise a field-programmable gate array.

11. The system of claim 10, wherein the logic devices of the field-programmable gate array are adapted to execute concurrently.

12. The system of claim 9, further comprising:
a signal communicated to a user when the signal of interest is identified.

13. The system of claim 9, wherein said digitized data stream is parameterized.

14. The system of claim 13, wherein the stream analyzer is further adapted to determine whether at least one of said plurality of programmable logic devices is programmed with a parameter of the parameterized data stream.

15. The system of claim 9, further comprising a third data storage structure adapted to store said digitized data stream.

16. The system of claim 9, wherein said second data structure further comprises an object database management system.

17. The system of claim 16, wherein said object database management system further comprises a high performance framework.

18. The system of claim 9, wherein the signal classifier further comprises:
an input/output device.

19. The system of claim 9, wherein the stream analyzer further comprises:
an input/output device.
